(19) United States
(12) Patent Application Publication
(10) Pub. No.: US 2017/0134746 A1
(43) Pub. Date: May 11, 2017

(54) MOTION VECTOR ASSISTED VIDEO STABILIZATION

(71) Applicant: INTEL CORPORATION, SANTA CLARA, CA (US)

(72) Inventors: SEAN J. LAWRENCE, Bangalore (IN); ANKITA TAPASWI, Pune (IN)

(73) Assignee: INTEL CORPORATION, SANTA CLARA, CA (US)

(21) Appl. No.: 14/934,925

(22) Filed: Nov. 6, 2015

(51) Int. Cl. H04N 19/527; H04N 19/176; H04N 19/625

(52) U.S. Cl. CPC H04N 19/527; H04N 19/625; H04N 19/176

(57) ABSTRACT

Video stabilization is described that is assisted by motion vectors. In one example global motion is estimated using global motion vectors in a compressed video stream. An object of interest is detected in the compressed video stream and motion of the object of interest is tracked in the compressed video stream using object motion vectors. Frames of the compressed video stream are adjusted to reduce motion of the object of interest using the object motion vectors.

### FIELD

The present description relates to the field of video image processing and, in particular, to stabilizing a video in compressed form using object motion.

### BACKGROUND

Digital video recording devices are becoming smaller, cheaper and more common and can now be found in a broad range of consumer electronic devices, including cellular telephones, smartphones, digital cameras, action cameras, and automobiles. The demand for video capture has been bolstered by new and growing online media services. Much of this content is stored and transmitted in a compressed format, such as mpeg4 to reduce storage and bandwidth requirements.

Video stabilization attempts to align video frames that are misaligned because hand motions or platform vibrations. As small, lightweight hand held devices are used more for video capture, more video suffers from this misalignment. To stabilize the video, the motion of the camera is estimated. This motion is then smoothed and compensated. Motion smoothing attempts to allow for slow intentional hand motions like panning and zooming. Motion compensation attempts to compensate for shaky unintentional hand motions.

Many of these devices offer built-in video processing technologies. The processing may be performed as the video is received or it may be performed later in a computer workstation. The processing may include stabilization, object tracking, object recognition, exposure compensation, and many others. Some forms of video stabilization make use of global motion vectors in a compressed video stream. These global motion vectors are used during decode to stabilize and present the video. In many cases, the global motion vectors may be used to remove the effects of the camera being shaken by the user. These stabilization techniques may be used to allow pleasing videos to be captured without the need for a stable support such as tripod or dolly.

### BRIEF DESCRIPTION OF THE DRAWINGS

Embodiments are illustrated by way of example, and not by way of limitation, in the figures of the accompanying drawings in which like reference numerals refer to similar elements.

FIG. 1 is a general process flow diagram for stabilizing video according to an embodiment.

FIG. 2 is a process flow diagram for stabilizing video with improved camera shake compensation according to an embodiment.

FIG. 3 is a process flow diagram for stabilizing video with improved object tracking according to an embodiment.

FIG. 4 is a process flow diagram for ensuring coordinates are within boundaries in FIG. 3 according to an embodiment.

FIG. 5 is a process flow diagram for stabilizing video with improved camera shake compensation and object tracking according to an embodiment.

FIG. 6 is a process flow diagram for ensuring coordinates are within boundaries in FIG. 5 according to an embodiment.

FIG. 7 is a block diagram of a computing device incorporating interactive video presentation according to an embodiment.

### DETAILED DESCRIPTION

Video stabilization using global motion vectors removes camera shake only within a narrow field of motion. As described herein, significant camera motion may also be compensated. In addition, the motion of an object in the captured scene may also be compensated. Using object motion vectors from a compressed video and object tracking techniques together with global motion vectors provides for a new video stabilization technique.

As described herein, object detection and tracking from compressed video streams are applied to video stabilization. Once an object of interest or a region of interest (ROI) has been detected or a previously detected object has been identified, then the motion vectors in the compressed stream may be used to identify the gross or global motion of the scene and the movement of the identified object. Motion vectors and DC coefficients may be used to track the detected object or region of interest. The global motion and the motion associated with the object or region of interest can be used to assist or complement more conventional stabilization techniques during decoding and rendering of the stabilized video.

The described approach provides video stabilization with a low level of computation. This is in part because the encoded video is not necessarily decoded but only parsed. Parsing the video stream for motion vector information and DC coefficients provides enough information for global and local motion estimation and for object detection and tracking.

At the same time, the video may also be stabilized with respect to object motion and not only camera shake. This logically improves the stabilization by minimizing deviations of the object from the center or some other intended location of the video screen.

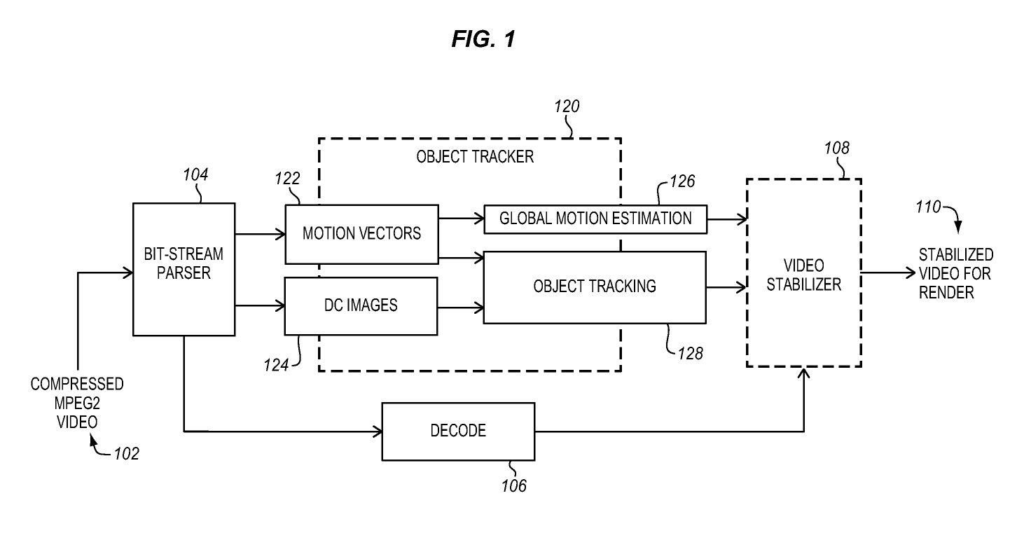

FIG. 1 is a diagram of a general process flow for stabilizing video. The incoming video stream 102 is a compressed sequence of image frames and may come directly from a camera or from storage. A variety of different compression formats may be used, such as MPEG-2 (Motion Pictures Experts Group), MPEG-4, H.264, AVC, etc. or any other compression type that allows for the extraction of motion vectors. The compressed video sequence or stream is applied to a bit-stream parser 104 and then to a decoder 106 which decompresses the video. At 108 the decoded video is applied to a video stabilizer 108 to produce a stabilized video stream 110 for rendering or storage or both.

By parsing 104 the compressed video stream 102, motion vectors 122, including global motion vectors and object vectors, and DC images 124 are obtained that can be used to assist with stabilizing the video during decoding and rendering. A motion vector represents the direction and distance that a particular area of an image moves between two adjacent frames. A DC coefficient or image represents a baseline pixel value (for example, corresponding to brightness or hue) for an n×n array of pixels referred to as a macro-block. The motion vector and DC coefficient data can be extracted from an encoded video stream without decoding by parsing data contained within the encoded stream. The parsing and extraction requires far less processing than even partially decoding the video stream.

The parser output is coupled to an object tracker 120. The extracted motion vectors 122 and DC images 124 are used by the object tracker to track objects 128 within the scene. The DC images may be those having macro-blocks that include the tracked object, i.e. the object of interest. Camera shake corrections may also be made using global motion estimation 126 from the global motion vectors 122. The different vectors may be used to determine and differentiate between global motion and object motion. Global motion is applied to reduce camera shake while object motion is used for tracking and to stabilize the video as described below.

Global motion estimation may be performed in different ways, depending on the implementation. In one example, global motion parameters are estimated from a sampled motion vector field. Gradient descent or another regression method may be used to select appropriate motion vectors that correspond to camera shake and remove motion vector outliers.

The video may be stabilized in a variety of different ways, depending on the nature of the video and the desired results. Three of these ways are presented in the drawing figures below. These may all be done using motion vectors from compressed video sequences. In a first example, the object motion contribution is isolated and then removed from the global motion estimation. This improves the global motion estimation by removing other unwanted effects. In a second example, object motion vectors are isolated and are used to stabilize the video with respect to a single object in a scene. In a third example, object motion vectors are isolated and then used to fine tune the global motion vectors. The global motion vectors are then used to stabilize the video.

These three ways are effective, in particular, where camera shake is introduced during video capture. This can be caused by the lack of a firm mount for the camera sensor. When the camera is held in a single position or when the camera follows an object for some significant amount of time, then the video will appear shaky without a firm mount for the camera. These techniques allow the video to be stabilized even when the camera is not securely held in place and even when the camera does not smoothly follow an object.

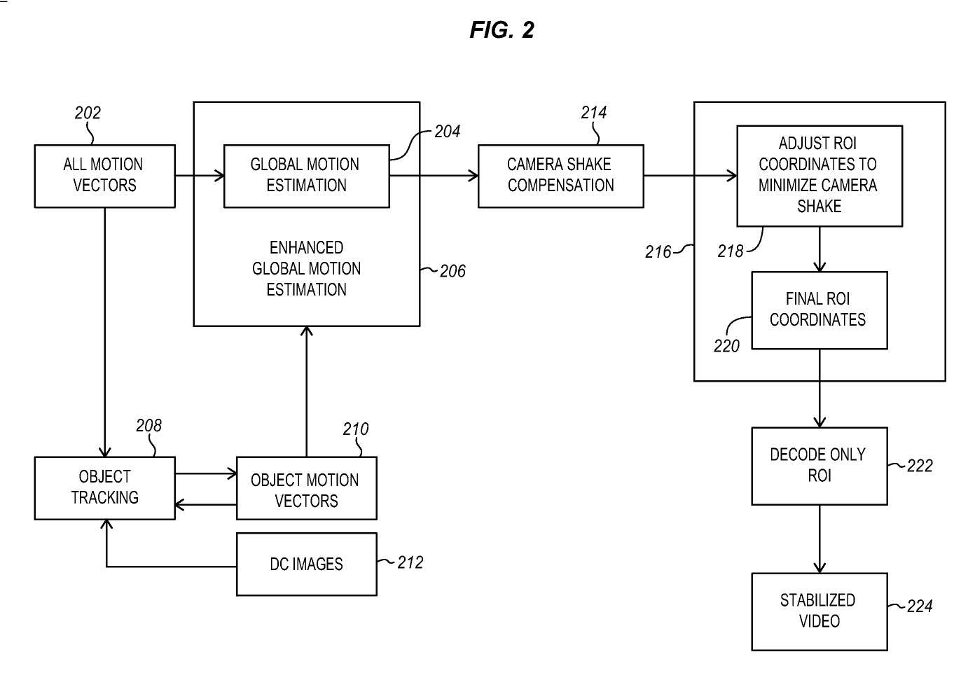

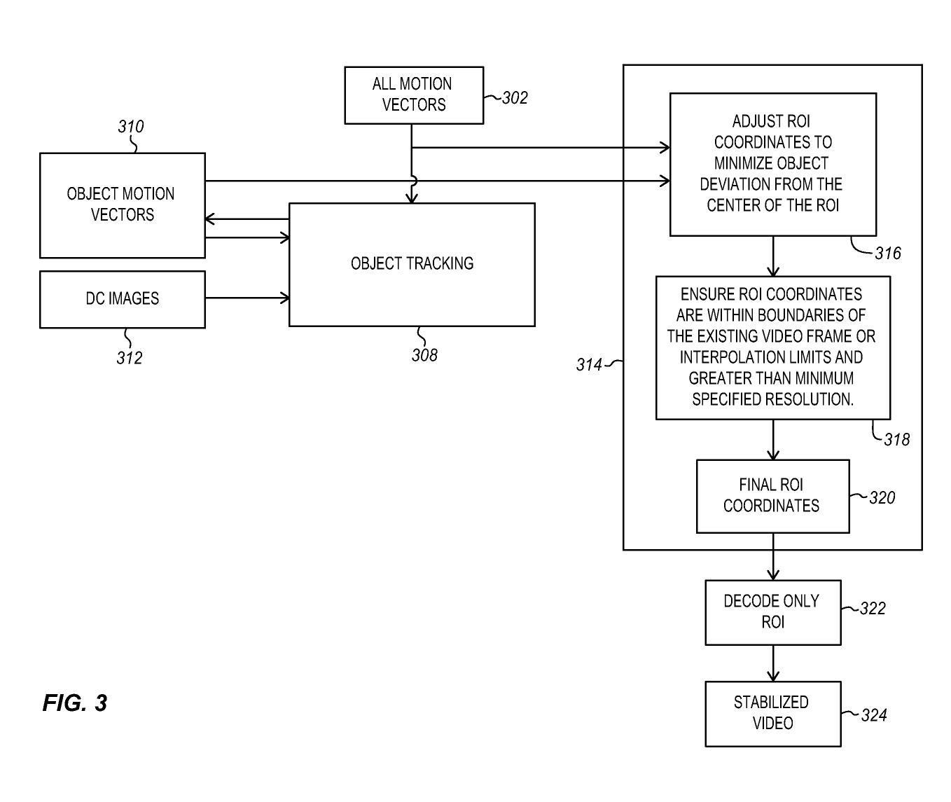

An example approach for the first example is shown in the block diagrams of FIGS. 2 and 3. Global motion vector-based methods calculate global motion by considering all of the motion vectors in a video frame. As a result, object motion also contributes to the global motion calculation. Once an object motion is identified, it can be removed from the global motion calculation and, as a result, improve the global motion calculation. This improves video stabilization. This is the first example in which the object motion vector contribution is isolated and removed from the global motion vectors.

FIG. 2 is a process flow diagram to illustrate one example flow. Motion vectors 202 are provided from a compressed video stream to a variety of different processes. Global motion vectors are extracted from the motion vectors using any suitable technique and used to determine a general global motion estimate 204. The motion vector information is extracted in the compressed domain by parsing the compressed stream. This information is then used to assist with stabilization during decompression and rendering as described in more detail below.

Object motion vectors are identified 210 using motion vectors and DC images 212 from the motion vectors 202 and applying any suitable object identification and motion tracking technique 208. In some embodiments the identified object in the DC images is regularly correlated in subsequent I-frames. Among other purposes, this helps to prevent drift and ensure that the motion vectors correspond to true motion. Enhanced global motion vectors are determined 206 by applying the object motion vectors 210 to the general global motion estimation 204. In one example, the motion contribution from the object motion vectors 210 is removed from the general global motion vector set.

The enhanced global motion vectors are then applied to compensate for camera shake 214 in the video. Global motion vectors typically correspond to camera shake and can be distinguished from the movement of an object of interest. Camera shake tends to be non-uniform with random motion. As a result it cannot be easily clustered into a uniform pattern. Movement of the object, on the other hand, will tend to be uniform and motion vectors for it will be clustered. Using this difference, the camera shake motion vectors may be disregarded when filtering for clustered motion vectors with uniform motion.

The camera shake reduced video is applied to a Region of Interest (ROI) compensation block 216. For the ROI compensation, the ROI coordinates are adjusted in one block 218. The coordinates are adjusted to minimize the effects of the determined camera shake. After this the final coordinates of the ROI are determined in another block 220. These final coordinates from the ROI coordinates are then applied to decode the ROI from the video at 222 and the result is the final stabilized video at 224. This video is produced without decoding every pixel of the captured scene but only those of the shake and global motion reduced ROI.

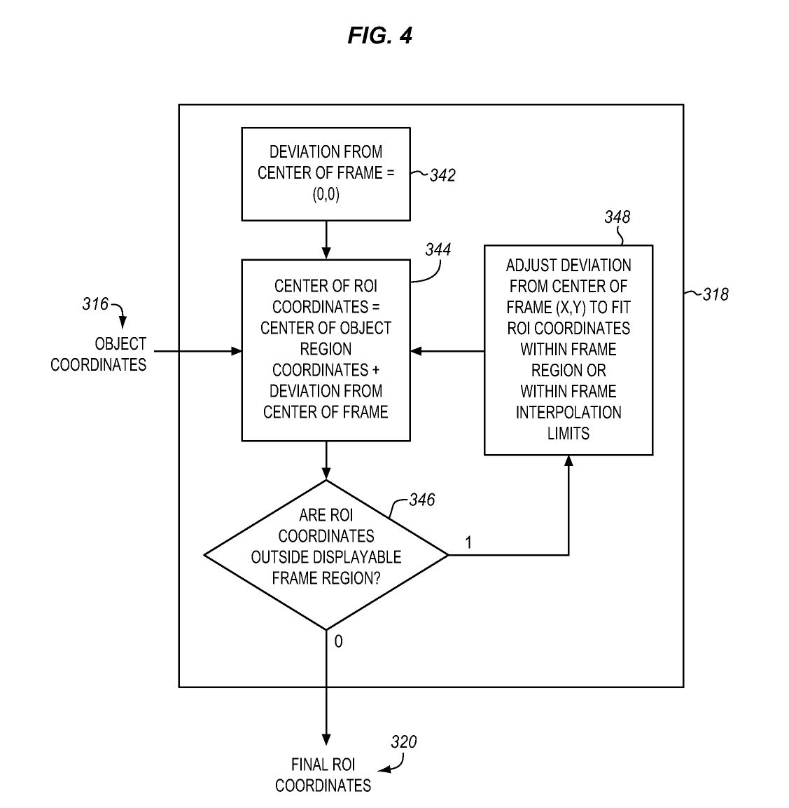

The second approach is shown as a process flow diagram in FIGS. 3 and 4. In this example, object motion vectors are isolated and then used to stabilize the video with respect to a particular selected object of interest. As in the example of FIG. 2, object motion vectors 310 are determined. The object motion and location is used to determine ROIs for each frame to then stabilize the video. Once an object region is determined, the coordinates within the frame are used to adjust 316 ROI such that the object region has minimum deviation from the center of the frame. The coordinates may also be adjusted 318 to ensure that the ROI selected is within frame boundary or within interpolation limits that are typically used for video stabilization.

As in FIG. 2, in FIG. 3, all of the motion vectors 302 are received. These are applied for identifying an object and tracking that object at 308 using any suitable technique. This process may use the object motion vectors 310 isolated by object tracking and also DC images 312. The object motion vectors are provided to the ROI coordinate adjustment 314.

The ROI coordinate adjustment has three stages as shown, however, more or fewer may be used. At the first stage 316 the ROI coordinates are adjusted to minimize object deviation from the center of the ROI. This will limit movement of the tracked object within the ROI. The second stage 318 ensures that the ROI coordinates are within the boundaries of the existing allowable video frame. This frame may be limited to the images captured by the camera sensor or the frame may be extended by interpolation, by reducing the resolution of the video and in other ways. The third stage 320 is to determine the final ROI coordinates. This data is then applied to decoding the ROI 322 to produce the stabilized video at 324.

FIG. 4 shows the second stage 318 of the ROI coordinate adjustment 314 of FIG. 3 in more detail. As shown the initially adjusted ROI coordinates are received from stage 1. At 342, the technique determines how much deviation there is in the received coordinates from the center of the frame. In this example the center of the frame is defined as coordinates (0,0) for a two-dimensional frame. The frame coordinates then have four quadrants into which a central point on the tracked object may move corresponding to positive and negative on the two orthogonal axes. At 344 this deviation 342 is applied to determine a center of the coordinates of the ROI. This center is determined as the center of the coordinates of the tracked object combined with the deviation of that object from the center of the frame (0,0).

The result for the ROI coordinates is applied to a test at 346 to determine whether the outer coordinates of the ROI are outside the allowed frame of the captured image. The allowed frame may be expanded by interpolation or in some other way. In some cases, the captured frame may be larger than the video frames. As an example, a camera may capture video at 1080p (1080 vertical lines of resolution) but the video may be rendered at 720p. This would allow the rendered frame to be moved up or down 180 lines and side-to-side with no loss of resolution. Similarly 4K video may be captured with a 5K sensor etc. Alternatively or in addition, if the ROI coordinates are beyond the edge of the captured video frame, some additional pixels may be provided at the edge of the frame by interpolation or another estimation technique.

If the ROI coordinates are within the allowed frame, then the adjusted ROI coordinates are sent to the third stage 320 to determine the final ROI coordinates. If the ROI coordinates are outside the allowed frame then at 348 the deviation or adjustment is changed. The deviation for the center (0,0) of the frame may be adjusted to fit the ROI coordinates within the allowed frame and then fed back to the determination 344 of the center of the ROI. The adjustment may be done in any of variety of different ways. In one example, the motion of the object of interest is being tracked. Depending on the rate of motion of this object in the video, the ROI may simply be moved within the frame in a single frame jump. The object may then be re-centered or re-positioned in the frame. If the object moves only slowly, then this will keep the object within the frame and will stay in the new position. Alternatively, the object may be changed. The previous object of interest may be allowed to move the edge and out of the frame and replaced by a different object of interest in the frame. The object may be stabilized at the center (0,0) of the frame or at any other selected position of the frame.

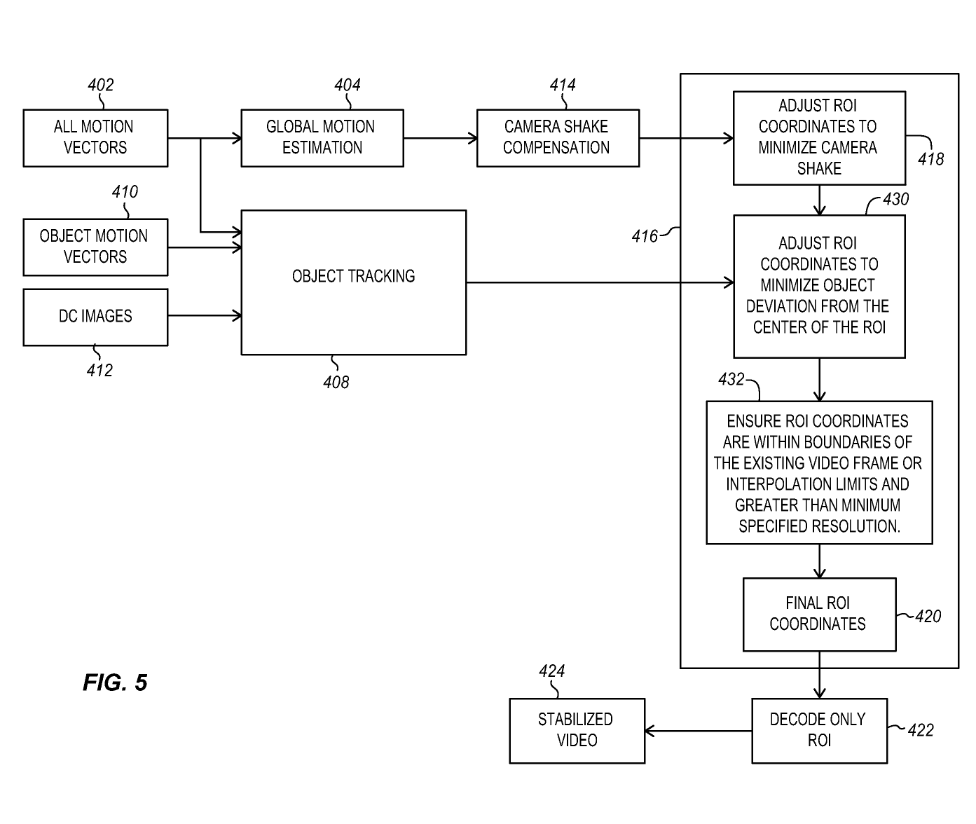

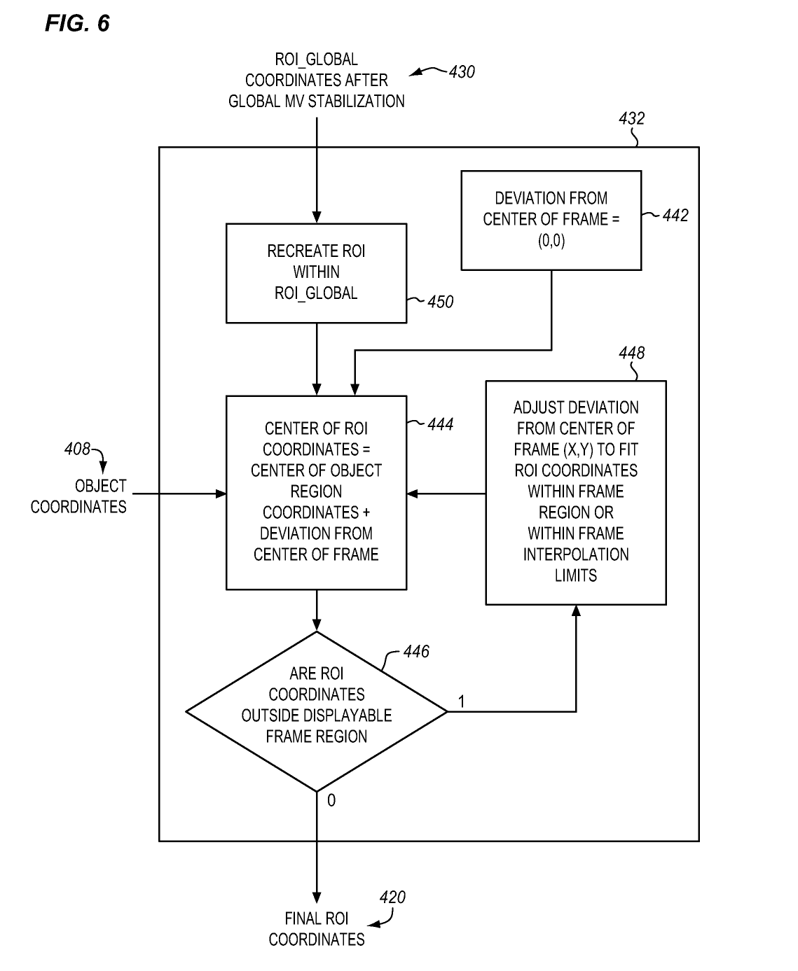

FIGS. 5 and 6 show the third approach mentioned above as process flow diagrams. In this example, object motion vectors are isolated and then used to fine-tune the global motion vectors. In this case, object motion vectors 410 are used to realign 430 the ROI after global motion has been compensated 418. Realignment is done such that the object region deviation from the center, or any other selected position, of the frame is minimized. The realignment is shown in more detail in FIG. 6.

In general global motion vectors are first used to estimate global motion 404 due to camera shake and used to determine a gross ROI. The object motion vectors 410 and DC images 412 are used for object tracking 408 and are used to try to minimize the deviation of the main object from the center of the screen 430. This enables the possibility of trying to keep the main object in focus at the center of the screen irrespective of the camera and object motion. The ROI determined from these two steps is done so within the boundary of the original frame (or within extrapolation limits) and within the minimum resolution specified 432.

Referring to FIG. 5, all motion vectors 402 are supplied to an object tracking technique 408 and to extract a global motion estimate 404. The object tracking 408 uses object motion vectors and DC images and the object tracking is supplied to an ROI coordinates adjustment block 416. The global motion estimation 404 is also provided to camera shake compensation 414 and the shake compensation is also provided to the ROI coordinates adjustment block 416.

The output of the ROI coordinates adjustment block is fed to a decoder 422 which then provides the stabilized video 424. The ROI adjustment block first adjusts the ROI coordinates to minimize camera shake 418 as in FIG. 2. This uses the camera shake compensation 414 determined from the global motion compensation 404. Then using the stabilized coordinates 418, the ROI coordinates are adjusted 430 to minimize the deviation of the object of interest, based on the object tracking 408, from the center of the ROI. The ROI coordinates may be adjusted to better suit the object of interest that is being trapped. These adjusted coordinates are then provided to a third stage that ensures that the ROI stays within the allowable frame.

The third stage of FIG. 5 works in a similar way to the second stage of the coordinate adjustment 314 of FIG. 3. This is shown in FIG. 6. FIG. 6 shows the third stage 432 of the ROI coordinate adjustment 416 of FIG. 5 in more detail. As shown the adjusted ROI global coordinates 430 are received from stage two after the global motion vector stabilization has been applied. With this, the ROI is recreated within the global motion vector stabilized region of interest coordinates at 450. At 442, the technique determines how much deviation there is in the received coordinates from the center of the frame. At 444 this deviation 442 is applied to determine a center of the coordinates of the ROI. The center is determined as the center of the coordinates of the tracked object combined with the deviation of that object from the center of the frame (0,0) or another selected position of the frame.

The result for the ROI coordinates is applied to a test at 446 to determine whether the outer coordinates of the ROI are outside the allowed frame of the captured image. If the ROI coordinates are within the allowed frame, then the adjusted ROI coordinates are sent to the third stage 420 to determine the final ROI coordinates. If the ROI coordinates are outside the allowed frame then at 448 the deviation or adjustment is changed. The results are passed to the fourth stage 420 to determine the final ROI coordinates.

As described herein, stabilization information is extracted by parsing compressed sequences of image frames or video streams. The described techniques may be used for video stabilization during capture and where stabilization of already encoded video is desired. Since the information used for stabilization can be extracted by parsing without requiring decoding, off-line stabilization is very efficient. Offline, stored video may be stabilized during the decoding and rendering of the video. This may be useful in many applications including server based applications that store large amounts of uploaded videos from users.

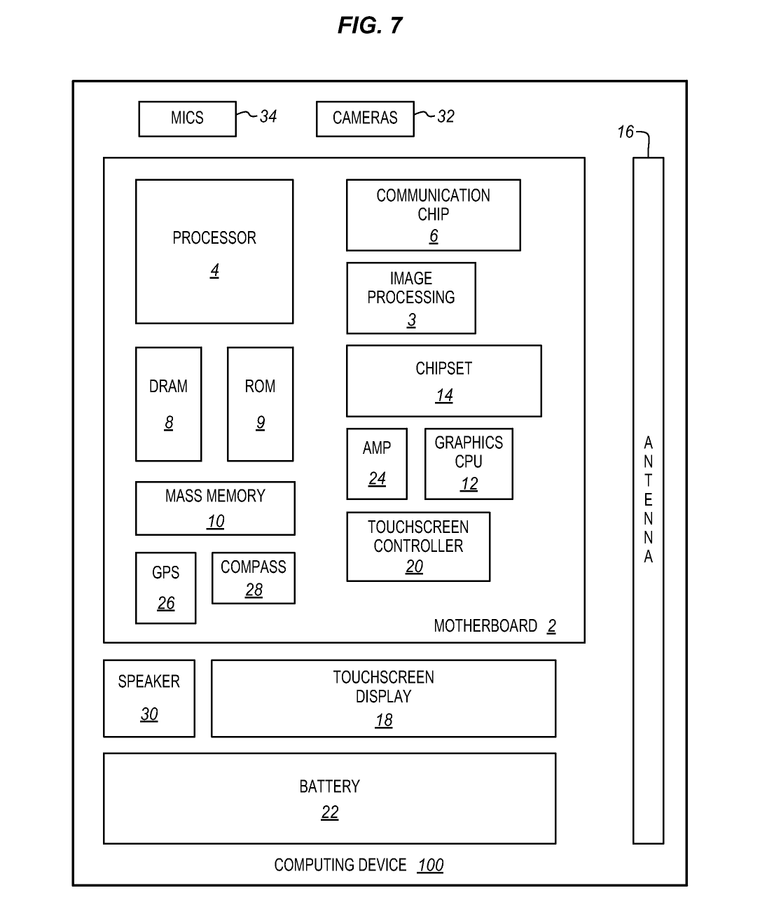

FIG. 7 is a block diagram of a single computing device 100 in accordance with one implementation. The computing device 100 houses a system board 2. The board 2 may include a number of components, including but not limited to a processor 4 and at least one communication package 6. The communication package is coupled to one or more antennas 16. The processor 4 is physically and electrically coupled to the board 2.

Depending on its applications, computing device 100 may include other components that may or may not be physically and electrically coupled to the board 2. These other components include, but are not limited to, volatile memory (e.g., DRAM) 8, non-volatile memory (e.g., ROM) 9, flash memory (not shown), a graphics processor 12, a digital signal processor (not shown), a crypto processor (not shown), a chipset 14, an antenna 16, a display 18 such as a touchscreen display, a touchscreen controller 20, a battery 22, an audio codec (not shown), a video codec (not shown), a power amplifier 24, a global positioning system (GPS) device 26, a compass 28, an accelerometer (not shown), a gyroscope (not shown), a speaker 30, a camera 32, a microphone array 34, and a mass storage device (such as hard disk drive) 10, compact disk (CD) (not shown), digital versatile disk (DVD) (not shown), and so forth). These components may be connected to the system board 2, mounted to the system board, or combined with any of the other components.

The communication package 6 enables wireless and/or wired communications for the transfer of data to and from the computing device 100. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication package 6 may implement any of a number of wireless or wired standards or protocols, including but not limited to Wi-Fi (IEEE 802.11 family), WiMAX (IEEE 802.16 family), IEEE 802.20, long term evolution (LTE), Ev-DO, HSPA+, HSDPA+, HSUPA+, EDGE, GSM, GPRS, CDMA, TDMA, DECT, Bluetooth, Ethernet derivatives thereof, as well as any other wireless and wired protocols that are designated as 3G, 4G, 5G, and beyond. The computing device 100 may include a plurality of communication packages 6. For instance, a first communication package 6 may be dedicated to shorter range wireless communications such as Wi-Fi and Bluetooth and a second communication package 6 may be dedicated to longer range wireless communications such as GPS, EDGE, GPRS, CDMA, WiMAX, LTE, Ev-DO, and others.

The cameras 32 are coupled to an image processing chip 3 to perform format conversion, coding and decoding, noise reduction and video stabilization as described herein. The processor 4 is coupled to the image processing chip to drive the processes, set parameters, and may participate in or perform some of the more complex functions, especially with video processing and stabilization. Video stabilization may also be performed using video stored in mass memory 10 or received through a network or other communications interface 6. The image processing chip 3 may assist with coding and decoding stored video or this may be performed by the processor. The processor 4 may include a graphics core or there may be separate graphics processor in the system. The decoded, stabilized video may be rendered on the local display 18, stored in memory 10, or sent to another device through network or other communications interface 6.

In various implementations, the computing device 100 may be eyewear, a laptop, a netbook, a notebook, an ultrabook, a smartphone, a tablet, a personal digital assistant (PDA), an ultra mobile PC, a mobile phone, a desktop computer, a server, a set-top box, an entertainment control unit, a digital camera, a portable music player, or a digital video recorder. The computing device may be fixed, portable, or wearable. In further implementations, the computing device 100 may be any other electronic device that processes data.

Embodiments may be implemented as a part of one or more memory chips, controllers, CPUs (Central Processing Unit), microchips or integrated circuits interconnected using a motherboard, an application specific integrated circuit (ASIC), and/or a field programmable gate array (FPGA).

References to “one embodiment”, “an embodiment”, “example embodiment”, “various embodiments”, etc., indicate that the embodiment(s) so described may include particular features, structures, or characteristics, but not every embodiment necessarily includes the particular features, structures, or characteristics. Further, some embodiments may have some, all, or none of the features described for other embodiments.

In the following description and claims, the term “coupled” along with its derivatives, may be used. “Coupled” is used to indicate that two or more elements co-operate or interact with each other, but they may or may not have intervening physical or electrical components between them.

As used in the claims, unless otherwise specified, the use of the ordinal adjectives “first”, “second”, “third”, etc., to describe a common element, merely indicate that different instances of like elements are being referred to, and are not intended to imply that the elements so described must be in a given sequence, either temporally, spatially, in ranking, or in any other manner.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

The following examples pertain to further embodiments. The various features of the different embodiments may be variously combined with some features included and others excluded to suit a variety of different applications. Some embodiments pertain to a method that includes estimating global motion using global motion vectors in a compressed video stream, detecting an object of interest in the compressed video stream, tracking motion of the object of interest in the compressed video stream using object motion vectors, and adjusting frames of the compressed video stream to reduce motion of the object of interest using the object motion vectors.

Further embodiments include adjusting frames of the compressed video stream to reduce camera shake using the global motion vectors.

Further embodiments include removing object motion from the global motion vectors before adjusting frames to reduce camera shake.

In further embodiments removing object motion comprises parsing object motion vectors for the object of interest from the compressed video stream and subtracting the object motion vectors for the object of interest from the global motion vectors.

Further embodiments include adjusting frames of the compressed video stream using DC images for a macro-block that includes the object of interest.

In further embodiments tracking the motion comprises parsing object motion vectors and DC images from the compressed video stream and applying the parsed object motion vectors and DC images to track the object.

7. The method of claim 6, wherein adjusting frames of the compressed video stream comprises applying the object motion vectors to adjust the coordinates of the frames.

Further embodiments include determining a region of interest in the frames of the compressed video stream and wherein adjusting frames comprises adjusting coordinates of the determined region of interest to reduce deviation of the object of interest from the selected position of the frames.

Further embodiments include limiting adjusting the coordinates so that the frames stay within allowed limits of movement.

Further embodiments include realigning the adjusted frames using the tracked motion of the object of interest.

Some embodiments pertain to an apparatus that includes a memory for storing a compressed video stream, a processor coupled to the memory to estimate global motion using global motion vectors in the compressed video stream, to detect an object of interest in the compressed video stream, to track motion of the object of interest in the compressed video stream using object motion vectors, and to adjust frames of the compressed video stream to reduce motion of the object of interest using the object motion vectors, and a video decoder to decode the compressed video stream with the adjusted frames and to store the decoded video stream in the memory for rendering.

In further embodiments the processor is further to modify the global motion vectors by removing object motion from the global motion vectors and to adjust frames of the compressed video stream to reduce camera shake using the modified global motion vectors.

In further embodiments removing object motion comprises parsing object motion vectors for the object of interest from the compressed video stream and subtracting the object motion vectors for the object of interest from the global motion vectors.

In further embodiments tracking the motion comprises parsing object motion vectors and DC images from the compressed video stream and applying the parsed object motion vectors and DC images to track the object.

In further embodiments the processor is further to realign the adjusted frames using the tracked motion of the object of interest.

Further embodiments include a machine-readable medium having instructions thereon that, when operated on by the machine, cause the machine to perform operations that include estimating global motion using global motion vectors in a compressed video stream, detecting an object of interest in the compressed video stream, tracking motion of the object of interest in the compressed video stream using object motion vectors, and adjusting frames of the compressed video stream to reduce motion of the object of interest using the object motion vectors.

In further embodiments tracking the motion comprises parsing object motion vectors and DC images from the compressed video stream and applying the parsed object motion vectors and DC images to track the object.

In further embodiments adjusting frames of the compressed video stream comprises applying the object motion vectors to adjust the coordinates of the frames.

Further embodiments include determining a region of interest in the frames of the compressed video stream and wherein adjusting frames comprises adjusting coordinates of the determined region of interest to reduce deviation of the object of interest from the selected position of the frames.

Further embodiments include limiting adjusting the coordinates so that the frames stay within allowed limits of movement.

Some embodiments pertain to a video stabilization system that includes a global motion estimation module to estimate global motion using global motion vectors in a compressed video stream, an object of interest module to detect an object of interest in the compressed video stream and track motion of the object of interest in the compressed video stream using object motion vectors, and a frame adjustment module to adjust frames of the compressed video stream to reduce motion of the object of interest using the object motion vectors.

In further embodiments the frame adjustment module adjusts frames of the compressed video stream to reduce camera shake using the global motion vectors.

In further embodiments the object of interest module further removes object motion from the global motion vectors before adjusting frames to reduce camera shake.

In further embodiments removing object motion comprises parsing object motion vectors for the object of interest from the compressed video stream and subtracting the object motion vectors for the object of interest from the global motion vectors.

In further embodiments tracking the motion comprises parsing object motion vectors and DC images from the compressed video stream and applying the parsed object motion vectors and DC images to track the object.

In further embodiments adjusting frames of the compressed video stream comprises applying the object motion vectors to adjust the coordinates of the frames.

Further embodiments include a region of interest module to determine a region of interest in the frames of the compressed video stream and wherein the frame adjustment module adjust frames by adjusting coordinates of the determined region of interest to reduce deviation of the object of interest from the selected position of the frames.

Further embodiments include limiting adjusting the coordinates so that the frames stay within allowed limits of movement.

In further embodiments the frame adjustment module realigns the adjusted frames using the tracked motion of the object of interest.

What is claimed is:

1. A method comprising:
estimating global motion using global motion vectors in a compressed video stream;
detecting an object of interest in the compressed video stream;
tracking motion of the object of interest in the compressed video stream using object motion vectors; and
adjusting frames of the compressed video stream to reduce motion of the object of interest using the object motion vectors.

2. The method of claim 1, further comprising adjusting frames of the compressed video stream to reduce camera shake using the global motion vectors.

3. The method of claim 2, further comprising removing object motion from the global motion vectors before adjusting frames to reduce camera shake.

4. The method of claim 3, wherein removing object motion comprises parsing object motion vectors for the object of interest from the compressed video stream and subtracting the object motion vectors for the object of interest from the global motion vectors.

5. The method of claim 1, further comprising adjusting frames of the compressed video stream using DC images for a macro-block that includes the object of interest.

6. The method of claim 1, wherein tracking the motion comprises parsing object motion vectors and DC images from the compressed video stream and applying the parsed object motion vectors and DC images to track the object.

7. The method of claim 6, wherein adjusting frames of the compressed video stream comprises applying the object motion vectors to adjust the coordinates of the frames.

8. The method of claim 1, further comprising determining a region of interest in the frames of the compressed video stream and wherein adjusting frames comprises adjusting coordinates of the determined region of interest to reduce deviation of the object of interest from the selected position of the frames.

9. The method of claim 8, further comprising limiting adjusting the coordinates so that the frames stay within allowed limits of movement.

10. The method of claim 1, further comprising realigning the adjusted frames using the tracked motion of the object of interest.

11. An apparatus comprising:
a memory for storing a compressed video stream;
a processor coupled to the memory to estimate global motion using global motion vectors in the compressed video stream, to detect an object of interest in the compressed video stream, to track motion of the object of interest in the compressed video stream using object motion vectors, and to adjust frames of the compressed video stream to reduce motion of the object of interest using the object motion vectors; and
a video decoder to decode the compressed video stream with the adjusted frames and to store the decoded video stream in the memory for rendering.

12. The apparatus of claim 11, wherein the processor is further to modify the global motion vectors by removing object motion from the global motion vectors and to adjust frames of the compressed video stream to reduce camera shake using the modified global motion vectors.

13. The apparatus of claim 12, wherein removing object motion comprises parsing object motion vectors for the object of interest from the compressed video stream and subtracting the object motion vectors for the object of interest from the global motion vectors.

14. The apparatus of claim 11, wherein tracking the motion comprises parsing object motion vectors and DC images from the compressed video stream and applying the parsed object motion vectors and DC images to track the object.

15. The apparatus of claim 11, wherein the processor is further to realign the adjusted frames using the tracked motion of the object of interest.

16. A machine-readable medium having instructions thereon that, when operated on by the machine, cause the machine to perform operations comprising:
estimating global motion using global motion vectors in a compressed video stream;
detecting an object of interest in the compressed video stream;
tracking motion of the object of interest in the compressed video stream using object motion vectors; and
adjusting frames of the compressed video stream to reduce motion of the object of interest using the object motion vectors.

17. The medium of claim 16, wherein tracking the motion comprises parsing object motion vectors and DC images from the compressed video stream and applying the parsed object motion vectors and DC images to track the object.

18. The medium of claim 17, wherein adjusting frames of the compressed video stream comprises applying the object motion vectors to adjust the coordinates of the frames.

19. The medium of claim 16, further comprising determining a region of interest in the frames of the compressed video stream and wherein adjusting frames comprises adjusting coordinates of the determined region of interest to reduce deviation of the object of interest from the selected position of the frames.

20. The medium of claim 19, further comprising limiting adjusting the coordinates so that the frames stay within allowed limits of movement.
